(19) United States
(12) Patent Application Publication
(10) Pub. No.: US 2015/0266190 A1
(43) Pub. Date: Sep. 24, 2015

(54) BLADE HEATING SYSTEM FOR A RAZOR

(71) Applicants: L.P.I. Consumer Products, Inc., Pompano Beach, FL (US); Display Matrix Corporation, Randolph, NJ (US)

(72) Inventors: William Bohmer, Randolph, NJ (US); Louis D. Tomassetti, Pompano Beach, FL (US)

(73) Assignees: L.P.I. Consumer Products, Inc., Pompano Beach, FL (US); Display Matrix Corporation, Randolph, NJ (US)

(21) Appl. No.: 14/222,191

(22) Filed: Mar. 21, 2014

(51) Int. Cl. B26B 21/48; B26B 21/58; B26B 21/40; B26B 21/22

(52) U.S. Cl. CPC B26B 21/48; B26B 21/222; B26B 21/58; B26B 21/4075; B26B 21/4056

(57) ABSTRACT

A razor blade cartridge containing two or more blades includes an electric circuit with a battery power source for controlled direction of current flow through the blades in order to heat the blades. The blades are connected by at least one blade connector having electrically conductive contacts for electrically connecting the blades in a series arrangement, wherein flow of the electric current through the blades causes the blades to be heated.

### BACKGROUND OF THE INVENTION

1. Field of the Invention

The present invention relates generally to razors for shaving and, more particularly, to a battery powered system in a razor having blade contacts to produce a contact pattern than facilitates a series connection for controlled heating of the blades of the razor.

2. Discussion of the Related Art

It is known that the cutting edge of a razor blade cuts hair more effectively when it is warm or hot. It is also common practice to place the razor blades under hot running water in order to heat the blades just prior to stroking the blades over the skin in order to cut the hairs. However, the heat cutting performance of the blades lasts only a short time during the beginning of the shaving stroke. Within seconds, the temperature of the skin surface, hairs and blade are quickly reduced due to exposure to the ambient air. Ideally, it is best to maintain the blades, including the cutting edges of the blades, heated to a warm temperature throughout the shaving process to achieve better performance and increased shaving comfort.

One particular prior art blade heating invention, disclosed in U.S. Pat. No. 6,817,101 B1 to Bohmer, provides a shaving system with a continuously heated blade cartridge throughout the shaving stroke. Heating the blades is attained by applying a measured amount of electric current to the blade cartridge by means of conductors connected to each side of the blade cartridge and extended in the form of contacts at the connection of the blade cartridge to a razor handle. Electric current is provided by a primary battery contained in a compartment in the razor handle. Current provided by the battery renders optimum heat generation in the blades of the cartridge and the degree of heat can be adjusted by means of resistors connected in series with the blades and the blade cartridge. A switch closes the circuit.

The present invention improves upon the shaving system disclosed in U.S. Pat. No. 6,817,101 B1 by providing a more efficient and effective blade connection means with conductive contacts that achieve an electrical contact pattern between the blades, and particularly a series connection for controlled direction of current flow through the blades.

### SUMMARY OF THE INVENTION

In a razor containing a plurality of conductive blades, a system is provided for selectively heating the blades to a controlled temperature range. The blade heating system includes an electric circuit with a battery power source and insulated blade contacts for controlled direction of current flow through the blades in order to heat the blades. The insulated blade contacts produce a contact pattern than facilitates a series connection with the blades and battery power source. The electric circuit further includes an on/off switch.

### OBJECTS AND ADVANTAGES OF THE INVENTION

Considering the foregoing, it is a primary object of the present invention to provide a blade heating system for a razor having insulated blade contacts to produce a contact pattern than facilitates a series connection between the blades and a battery power source.

It is a further object of the present invention to provide a blade heating system in a razor the efficiently heats the blades secured in the blade cartridge.

These and other objects and advantages of the present invention are more readily apparent with reference to the following detailed description and the accompanying drawings.

### BRIEF DESCRIPTION OF THE DRAWINGS

For a fuller understanding of the nature of the present invention, reference should be made to the following detailed description taken in conjunction with the accompanying drawings in which:

FIG. 1 is a schematic illustration showing the electric circuit of the razor with a blade cartridge having a blade heating system of the present invention;

FIG. 2 is a top plan view showing the blade cartridge having a blade heating system of the present invention;

FIG. 3 is a bottom plan view showing the blade cartridge having a blade heating system of the present invention;

FIG. 4 illustrates a perspective view of a segmented contact blade connector for securing the one or more blades in the blade cartridge and serving as a conductor for directing controlled electric current flow through the one or more blades;

FIGS. 5A-5C illustrate front views and a side view of the segmented contact blade connector showing a conductive contact and an extended conductive connector;

FIGS. 6A-6C illustrate front views and a side view of the segmented contact blade connector illustrating a conductive contact and a conductive connector;

FIG. 7 is a general schematic diagram showing one embodiment wherein three blades are electrically connected in series and the positive and negative terminal conductor contacts are on opposite sides, i.e., opposite blade connectors;

FIG. 8 is a general schematic diagram showing another embodiment wherein six blades are electrically connected in series and the positive and negative terminal conductor contacts are on opposite sides, i.e., opposite blade connectors;

FIG. 9 is a top side view of the blade cartridge illustrating another embodiment wherein six blades are electrically connected in series and the positive and negative terminal conductor contacts are the same side, i.e., the same blade connector; and

FIG. 10 is a perspective view illustrating six blades having right angle extensions place sequentially.

Like reference numerals refer to like parts throughout the several views of the drawings.

### DETAILED DESCRIPTION OF THE PREFERRED EMBODIMENTS

Referring to the several views of the drawings, the razor blade cartridge having a blade heating system of the present invention is shown and is generally indicated as 20.

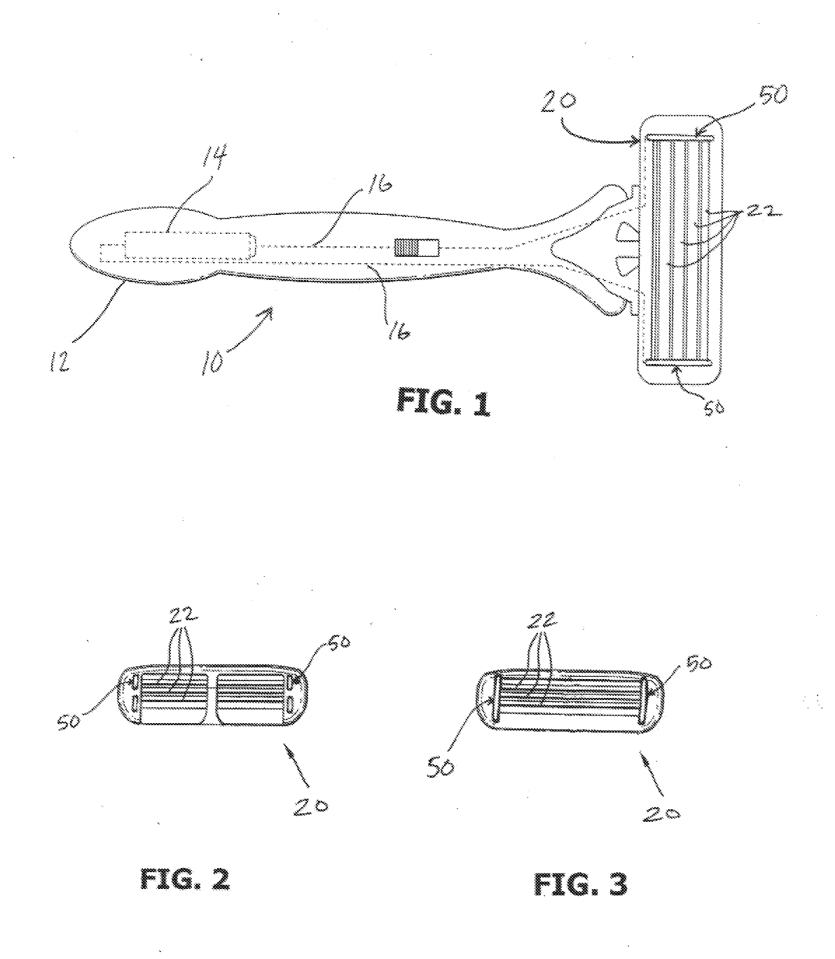

Referring initially to FIG. 1, a razor 10 having a handle 12 is shown with a blade cartridge 20 having a blade heating system attached thereto. The blade cartridge 20 may be affixed to a handle 12 in a manner wherein the entire razor 10 is disposed of after several uses for shaving. Alternatively, the blade cartridge 20 may be removably attachable to a handle 12 wherein the blade cartridge 20 is separated from the handle 12 and discarded after several uses when the blades 22 begin to dull. Thereafter, a new blade cartridge 20 can be attached to the handle 12. A battery power source 14 in the handle 12 or blade cartridge 20 provides an electric current flow through the circuit of the blade heating system, including conductive wires 16, segmented contact blade connectors 50, and blades 22.

The razor 10 includes an ON/OFF switch 18, such as a slide switch, on the handle 12 or the blade cartridge 20 for activating and deactivating the blade heating system. Subsequent movement of the ON/OFF switch 18, in the same action, serves to open the circuit, thereby deactivating the blade heating system. The ON/OFF switch 18 also may be a push button type switch or other type of switch that can be easily and conveniently operated between the ON/OFF conditions.

Referring to FIGS. 2 and 3, blade connectors 50 are attached to opposing sides of the blade cartridge 20. The blades 22 are secured to the blade connectors, which wrap around the blades 22 to keep the blades 22 correctly aligned for shaving.

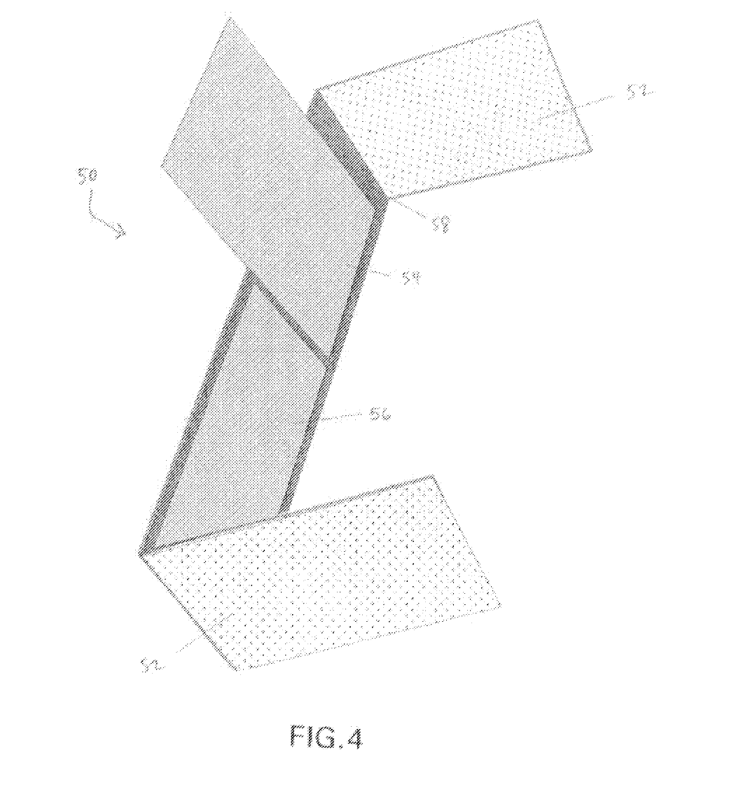

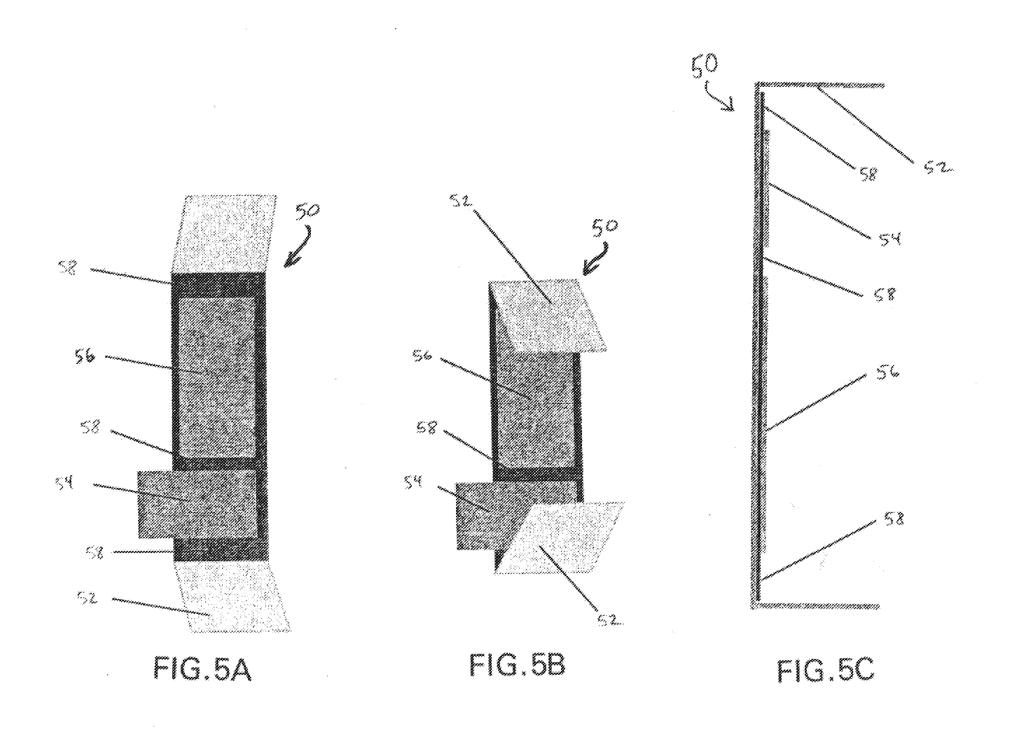

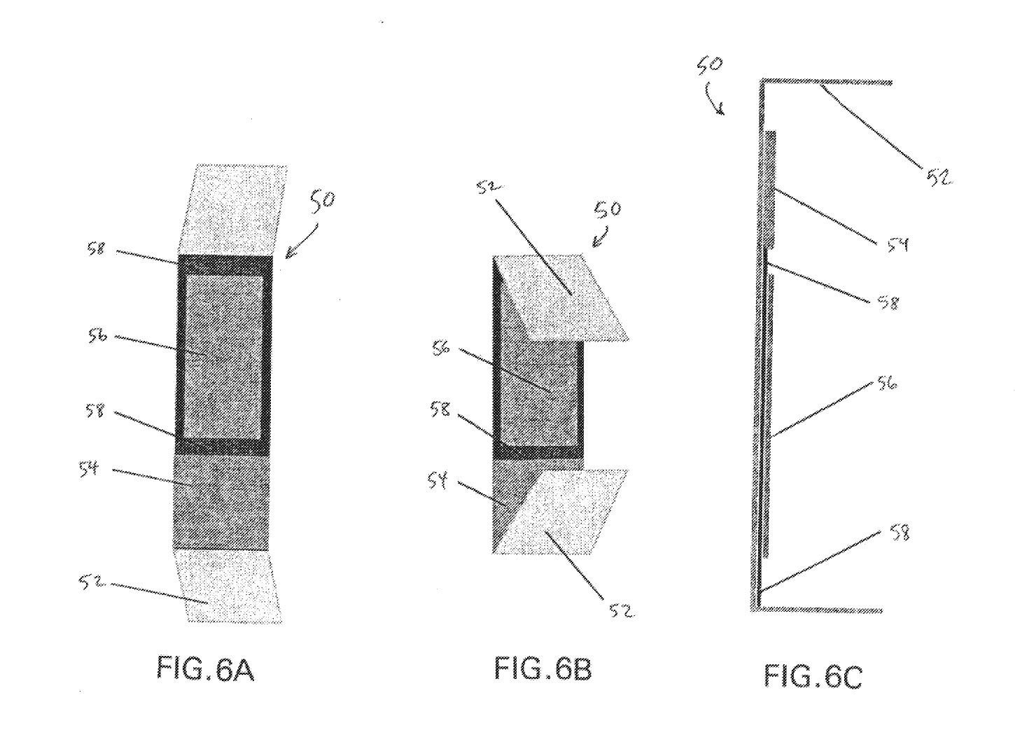

Referring to FIGS. 4 and 5A-5C, a first embodiment of a segmented contact blade connecter 50 is shown. Each blade connector 50 is made of a moldable (i.e., bendable) material, which may be conductive or non-conductive, and includes a central zone 51 and side flaps 52. The side flaps 52 on each blade connector 50 fold over the blades 22 to secure the blades 22 in place within the blade cartridge 20. Each blade connector 50 further includes an insulated contact pattern having an extended conductive connector 54 and an isolated conductive contact 56. If the blade connector 50 is made of a conductive material, a non-conductive film insulator 58 is provided between the blade connector 50 and conductive connectors and contacts 54 and 56. Embodiments of the blade connector 50 wherein the material(s) used to form the central zone 51 and side flaps 52 are non-conductive would not require a non-conductive film insulator 58. The conductive connectors 54 and conductive contacts 56 are positioned to be electrically connected in series with the blades 22, and a battery power source 14. Referring to FIGS. 6A-6C, a second embodiment of the segmented blade connector 50 is shown, wherein the conductive connector 54 does not extend beyond the perimeter of the blade connector 50. As with the embodiment shown in FIGS. 5A-5C, the conductive connectors 54 and conductive contacts 56 shown in FIGS. 6A-6C are positioned to be electrically connected in series with the blades 22, and a battery power source 14.

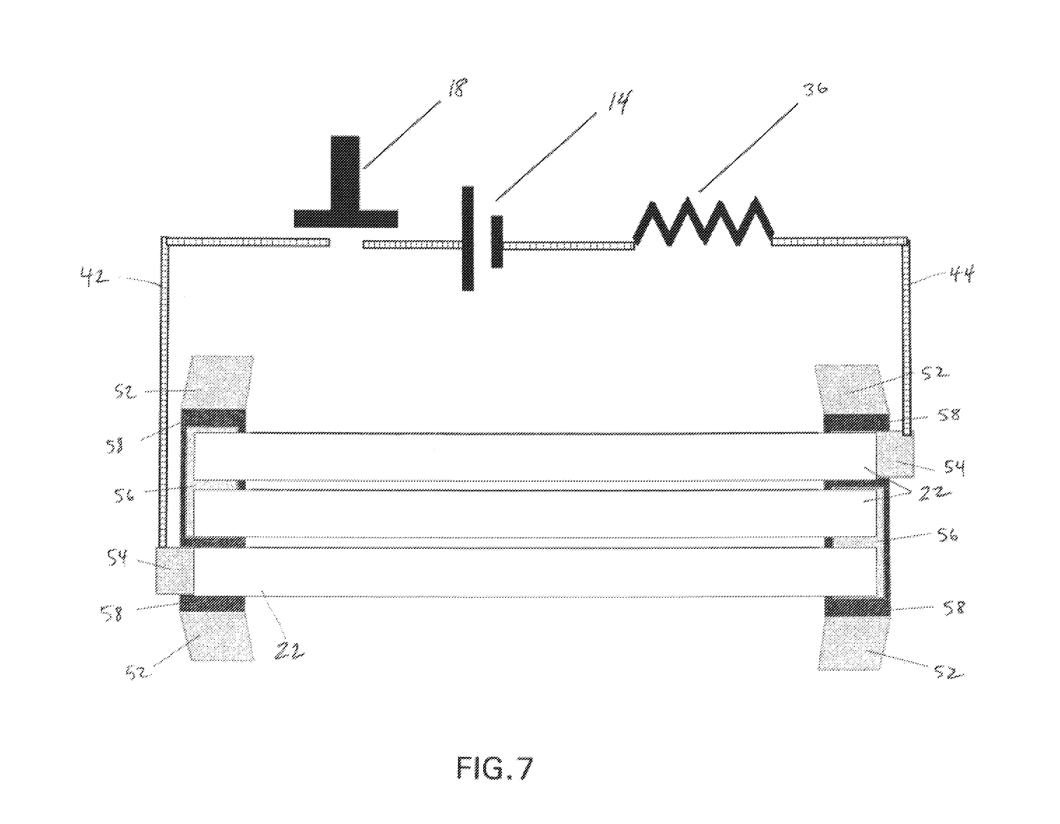

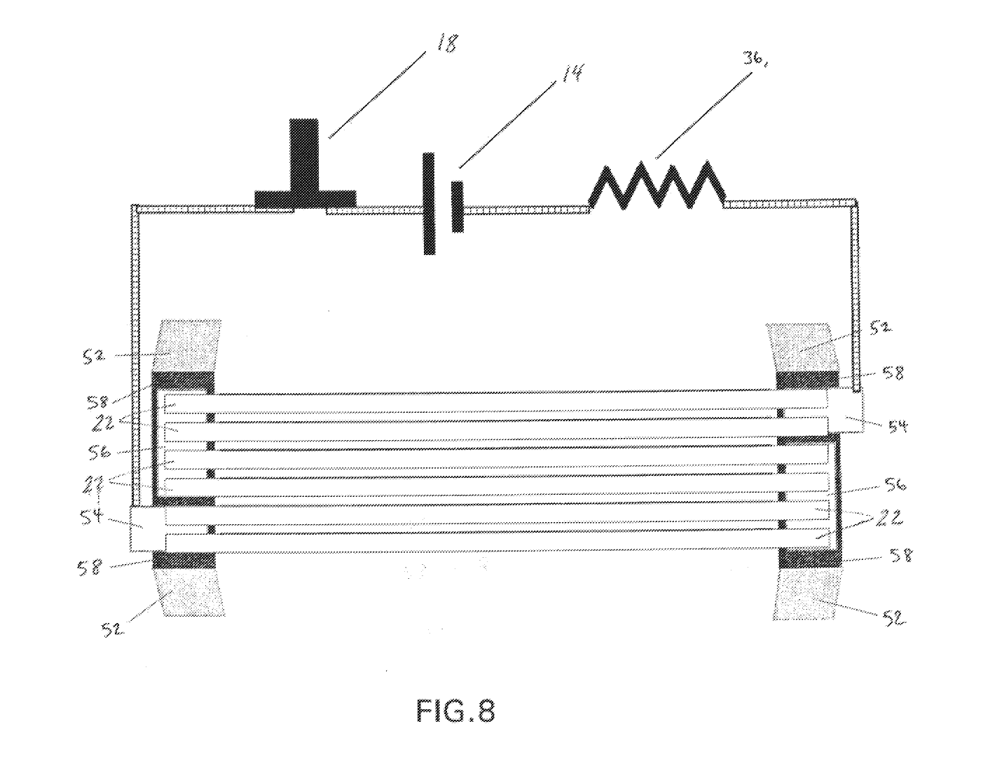

Electric current flow through the blades 22 is achieved by connecting one end of the conductive wiring 16 to the conductive connectors 54 on the segmented contact blade connector 50 and the opposite end to the positive and negative terminals of the battery power source 14 (see FIGS. 7 and 8). Conductive contacts 56 on opposite sides of the segmented contact blade connector 50 provide electrical connection points for continuing the series between the separate blades 22. The segmented contact blade connecter 50 and resulting electrical series connection provides a more efficient system for heating multiple razor blades than conventional parallel methods and, therefore, requires smaller and less expensive battery sources 14.

Examples of the series blade connections in the circuit are shown in FIGS. 7-9, as described in more detail hereinafter. The blade heating system circuit may further be provided with a timer or other device (e.g., a tilt switch) for opening the circuit, thereby deactivating (i.e., turning off) the blade heating system, in the event the user forgets to turn the blade heating system off by deactivating the system using the ON/OFF switch 18. In this instance, the circuit will be opened, thereby turning off the blade heating system, after a predetermined period of time has lapsed or by some other action (e.g., a tilt switch) that is normally performed when a user has completed the shaving process. As further illustrated in FIGS. 7-9, a temperature control switch 36 may be included for adjusting the heated temperature of the blades 22. The resistance of each of the conductive contacts 56 can be selectively adjusted to alter the flow of electric current through the blades 22 for regulating the temperature of the blades 22.

FIG. 7 illustrates an example wherein three blades 22 are electrically connected in series and the positive and negative terminal conductor contacts are on opposing sides, i.e., opposite blade connectors 50. As shown, the circuit may be closed using the slide switch or pressure actuated switch 18, thereby directing controlled electric current flow through the three blades 22 electrically connected in series.

FIG. 8 illustrates a further embodiment wherein six blades 22 are electrically connected in series and the positive and negative terminal conductor contacts are on opposing sides, i.e., opposite blade connectors 50. The blade heating system having segmented contact blade connecters 50 can be utilized with an odd number of blades 22 (FIG. 7) or even number of blades 22 (FIG. 8).

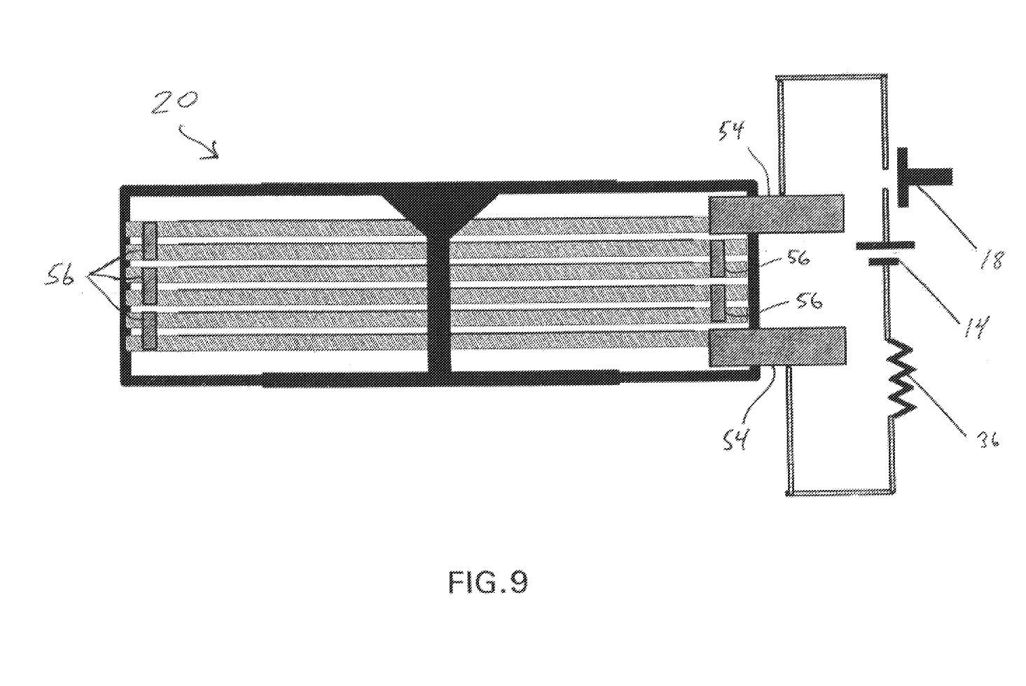

FIG. 9 illustrates a further embodiment of the blade heating system wherein both conductive connectors 54 of the series are on the same side, i.e., the same blade connector 50.

While each of the examples illustrated in FIGS. 7-9 shows the conductive contacts 56 in contact with the end of a blade 22, the contacts 56 may alternatively be in contact with the blade 22 at a location in between the end and the middle of the blade 22, thereby making the conductive contacts 56 on opposing sides of the blades 22 closer together.

Use of the segmented contact blade connecter 50 in combination with blades 22 for producing a series connection to direct current flow from the end (or some point) of one blade to the beginning (or some point) of the next blade (in whichever series configuration is desired) is a more efficient way of heating multiple blades than conventional parallel methods. Consequently, smaller and less expensive disposable batteries, which are an ideal power source for disposable plastic razors and disposable/replaceable blade cartridges, provide a suitable battery power source 14 for heating the blades 22.

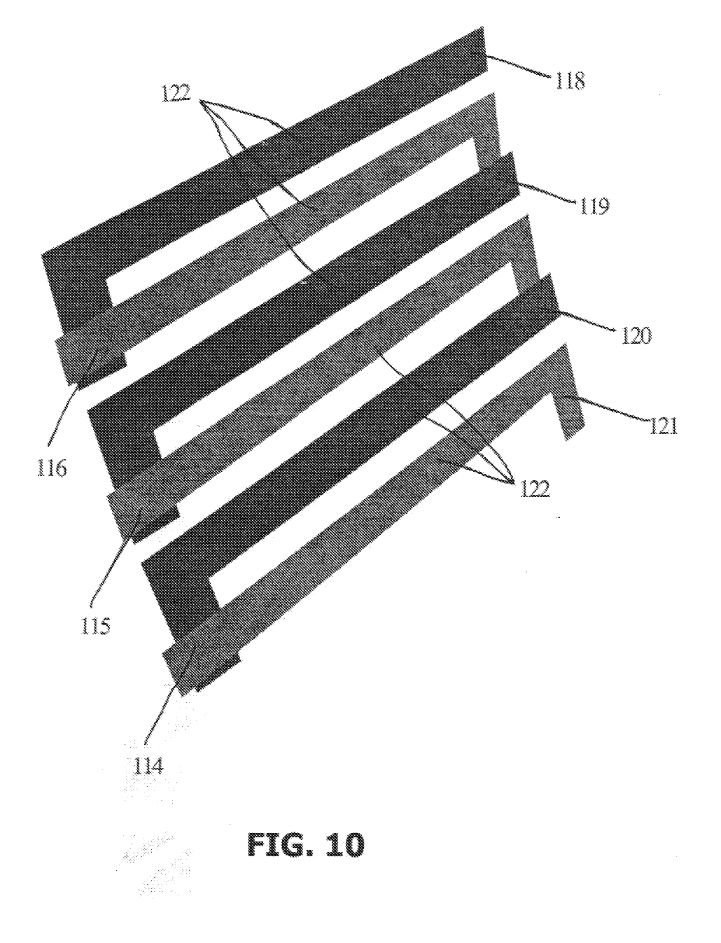

Referring to FIG. 10, modified blade shapes are used to produce a series circuit with a simple non-conductive staple. FIG. 10 illustrates six blades 122 forming a series connection at locations 114, 115, 116, 119 and 120 wherein the right angle extension tab meets the straight end of the subsequent blade 122 to produce a six blade series circuit with connections for power at locations 118 and 121.

While the present invention has been shown and described in accordance with several preferred and practical embodiments, it is recognized that departures from the instant disclosure are contemplated within the spirit and scope of the present invention which are not to be limited except as defined in the following claims as interpreted under the Doctrine of Equivalents.

What is claimed is:

1. A blade heating system for a razor, and said blade heating system comprising:
a blade cartridge being structured and disposed for holding a plurality of electrically conductive blades;
at least one blade connector on said blade cartridge that is adapted for securing said plurality of electrically conductive blades in said blade cartridge; and
at least one conductive contact on said at least one blade connector for electrically connecting said plurality of blades to an electric power storage source for delivering electric current to said plurality of electrically conductive blades, said at least one conductive contact being structured and disposed for electrically connecting said plurality of electrically conductive blades in series arrangement, wherein flow of the electric current through said plurality of blades causes said plurality of blades to be heated.

2. The blade heating system as recited in claim 1 wherein the resistance of said at least one conductive contact can be selectively adjusted to alter the flow of electric current through said plurality of blades for regulating the temperature of said heated plurality of blades.

3. The blade heating system as recited in claim 1 further comprising a switch selectively operable between an ON status for allowing the electric current flow through said plurality of blades and an OFF status for interrupting the electric current flow through said plurality of blades.

4. The blade heating system as recited in claim 1 wherein said at least one blade connector is non-conductive.

5. The blade heating system as recited in claim 1 further comprising a non-conductive film insulator located in between said at least one blade connector and said at least one conductive contact.

6. A blade heating system for a razor, and said blade heating system comprising:
a blade cartridge being structured and disposed for holding a plurality of electrically conductive blades;
a first blade connector and a second blade connector on said blade cartridge each being adapted for securing said plurality of electrically conductive blades in said blade cartridge; and
at least one conductive contact on said first and second blade connectors for electrically connecting said plurality of blades to an electric power storage source for delivering electric current to said plurality of blades, said at least one conductive contact being structured and disposed for electrically connecting said plurality of electrically conductive blades in series arrangement, wherein flow of the electric current through said plurality of blades causes said plurality of blades to be heated.

7. The blade heating system as recited in claim 6 wherein the resistance of said at least one conductive contact can be selectively adjusted to alter the flow of electric current through said plurality of blades for regulating the temperature of said heated plurality of blades.

8. The blade heating system as recited in claim 6 further comprising a switch selectively operable between an ON status for allowing the electric current flow through said plurality of blades and an OFF status for interrupting the electric current flow through said plurality of blades.

9. The blade heating system as recited in claim 6 wherein said first and second blade connectors are oppositely disposed on opposing ends of each of said plurality of electrically conductive blades.

10. The blade heating system as recited in claim 6 wherein each of said first and second blade connectors is non-conductive.

11. The blade heating system as recited in claim 6 further comprising a non-conductive film insulator located in between each of said first and second blade connectors and said at least one conductive contact.

12. A blade heating system for a razor, and said blade heating system comprising:
a blade cartridge being structured and disposed for holding a plurality of electrically conductive blades;
a first blade connector and a second blade connector on said blade cartridge each being adapted for securing said plurality of electrically conductive blades in said blade cartridge; and
a plurality of conductive contacts on said first and second blade connectors for electrically connecting said plurality of blades to an electric power storage source for delivering electric current to said plurality of blades, said plurality of conductive contacts being structured and disposed for electrically connecting said plurality of electrically conductive blades in series arrangement, wherein flow of the electric current through said plurality of blades causes said plurality of blades to be heated.

13. The blade heating system as recited in claim 12 wherein the resistance of each of said plurality of conductive contacts can be selectively adjusted to alter the flow of electric current through said plurality of blades for regulating the temperature of said heated plurality of blades.

14. The blade heating system as recited in claim 12 further comprising a switch selectively operable between an ON status for allowing the electric current flow through said plurality of blades and an OFF status for interrupting the electric current flow through said plurality of blades.

15. The blade heating system as recited in claim 12 wherein said first and second blade connectors are oppositely disposed on opposing ends of each of said plurality of electrically conductive blades.

16. The blade heating system as recited in claim 12 wherein each of said first and second blade connectors is non-conductive.

17. The blade heating system as recited in claim 12 further comprising a non-conductive film insulator located in between each of said first and second blade connectors and each of said plurality of conductive contacts.
